(19) United States
(12) Patent Application Publication
(10) Pub. No.: US 2005/0144305 A1
(43) Pub. Date: Jun. 30, 2005

(54) Systems and methods for identifying, segmenting, collecting, annotating, and publishing multimedia materials

(75) Inventors: Michael P. Fegan II, Fenton, MI (US); Brandon C. Furtwangler, Caledonia, MI (US); Mark L. Kornbluh, Okemos, MI (US); Dean A. Rehberger, Haslett, MI (US); Steven N. Furtwangler, Caledonia, MI (US)

Correspondence Address: Robert A. Goetz;MEDLEN & CARROLL, LLP, Suite 350, 101 Howard Street, San Francisco, CA, 94105, US

(73) Assignee: The Board of Trustees Operating Michigan State University, East Lansing, MI (US)

(21) Appl. No.: 10/970,482

(22) Filed: Oct. 21, 2004

Related U.S. Application Data
(60) Provisional application No. 60/512,982, filed on Oct. 21, 2003.

(51) Int. Cl. G06F 15/16

(52) U.S. Cl. 709/231

(57) ABSTRACT

The present invention relates to systems and methods for identifying, segmenting, collecting, annotating, and publishing multimedia materials. In some embodiments, the present invention provides a comprehensive server-side system for editing, annotating, managing and presenting multimedia events from a plurality of multimedia sources.

This application is a conversion of U.S. Provisional Patent Application Ser. No. 60/512,982, filed Oct. 21, 2003, herein incorporated by reference in its entirety.

The present invention was made, in part, under funds from National Science Foundation Grant Nos: IIS 9817485 and IIS 0229808. The government may have some rights in the invention.

### FIELD OF THE INVENTION

The present invention relates to systems and methods for identifying, segmenting, collecting, annotating, and publishing multimedia materials. In some embodiments, the present invention provides a comprehensive server-side system for editing, annotating, managing and presenting multimedia events from a plurality of multimedia sources.

### BACKGROUND OF THE INVENTION

Multimedia content is rapidly becoming pervasive on the World Wide Web portion of the Internet. As Internet connections have become faster, increasing amounts of multimedia content such as streamed audio or visual material have become available for public access. Streamed multimedia content has many advantages over traditional multimedia content (i.e., content that must be downloaded in its entirety in order to be accessible). For example, streamed content avoids both the time delay and the storage requirement associated with downloading a large multimedia file in its entirety to an access device such as a personal computer. Streaming also allows access to multimedia materials that content owners have not made available for downloading in their entireties (e.g., songs on Internet radio). While there has been continuing increases in multimedia content on the Internet and increasing speed, the use of streaming media, and multimedia events in general, over electronic communication networks is still in need of improved systems that provide greater flexibility and ease-of-use. In particular, the art is in need of systems and methods that allow users of multimedia content to manage, compile, archive, annotate, and flexibly present multiple multimedia events.

### SUMMARY OF THE INVENTION

The present invention relates to systems and methods for identifying, segmenting, collecting, annotating, and publishing multimedia materials that are stored on remote servers. In some embodiments, the present invention provides a comprehensive server-side system for managing and presenting multimedia events from a plurality of multimedia sources.

Working with online, multimedia objects has been expensive and requires the user to have a good deal of technical expertise. For example, in order for a user to segment streaming media, the user would have to download a copy of the digital object and use specialized software to edit the digital objects into multiple files that contain the portion of content that the user desires. To publish the digital excerpts on the web, the user would then need—again—specialized authoring tools and expertise to construct multimedia presentation using the clips that the user collects. Downloading and editing digital objects from the web not only presents technical problems for most users, but also brings with it problems of copyright and ownership.

The systems and methods of the present invention avoid these problems by, in preferred embodiments, only storing the url/uri (a web pointer) to the digital object. To isolate a piece of the digital object, the user only has to press “begin recording” and “end recording.” This—again—does not store bits of the digital object, but simply the time offsets that the user has selected. The application then uses the url/uri and time offsets to play the portion of the digital object that the user has selected, and provides a means to add the user's own thinking to those portions of media. The technical tools for carrying out the multimedia presentation are maintained on the server-side, rather than forcing the user on the client-side to navigate the difficulties of the management of the multimedia files.

Thus, in addressing the limitations of the prior art, the present invention provides comprehensive systems for identifying, segmenting, collecting, annotating, and publishing multimedia materials. In preferred embodiments, the systems and methods are hosted in an entirely server-side environment, such that client computers can identify, segment, collect, annotate, organize, and publish complex multimedia presentations containing multimedia files or portions of multimedia files from a plurality of sources (e.g., any web site offering multimedia on the internet). In some such preferred embodiments, the identity of the files, the annotations, and the organization of the files is stored and managed on the host network. In preferred embodiments, the multimedia files are maintained only on the third party web sites and are not copied onto the host or client computers. An advantage of such systems is the ability to manage complex presentations without burdening the client's computer hardware and allowing access to the presentation from any number of client computers. Specific illustrative, non-limiting embodiments of the present invention are described below in the Detailed Description of the Invention.

In preferred embodiments, the systems of the present invention are made available to client computers in an online environment. Use of the systems of the present invention online creates flexibility and ease-of-use for developing, managing, and using presentations that contain multimedia information. For example, the systems of the present invention allow users to find, segment, annotate, organize, and publish streaming media on the World Wide Web. In preferred embodiments, information is accessed by the user through the use of convenient bookmarks and hyperlinks. For example, a user's browser's bookmark feature is used to launch the application. In some preferred embodiments, the system of the present invention provides ease-of-use in assembling a presentation. For example, in some embodiments, the system selects an appropriate multimedia player (e.g., with selection based on the nature of the content to be played) and finds and loads the desired media into an editor. The media is displayed to the user along with annotation tools that allow the user to isolate portions of the media relevant to the presentation and to annotate the media as desired. In some embodiments, each user has a personal “portal” hosted on the system of the present invention that allows the user to edit and organize collected materials and to create complex publications and presentations that include multimedia clips and annotations.

In preferred embodiments, the system is maintained entirely on the server-side. The server (host) system manages the appropriate databases (e.g., user information, multimedia file location information, annotations, start and stop points, etc.). The present invention is not limited to particular types or kinds of server-side software. In some preferred embodiments, the databases are driven by MYSQL, freely available database software for Unix and Win32/WinNT (see, e.g., MYSQL, Second Edition, by Paul DuBois, Pearson Education, 2003, herein incorporated by reference in its entirety). In some preferred embodiments, the features of the present invention are encoded in PHP and JavaScript, with an XML-based delivery and display (see, e.g., Advanced PHP Programming, George Schlossnagle, SAMS, 2003, herein incorporated by reference in its entirety). Software and tools for use in the present invention is described and available at MATRIX, Michigan State University (Lansing, Mich.) (matrix.msu.edu/innermatrix/about.php). One advantage of this system is the ability to publish and present multimedia events with no proliferation of the digital files encoding the multimedia events (i.e., embodiments of the present invention provide a pointer to the media rather than a copy of the media).

Additional systems for generating, transmitting, formatting and using streaming media and other multimedia events are known in the art (see, e.g., U.S. Pat. No. 6,418,421 and U.S. patent application Nos. 20030001904, 20030191816, 20030163815, 20030163527, 20030158813, 20030154277, 20030140121, 20030133700, 20030126603, 20030113100, 20030110297, 20030110236, 20030106063, 20030101230, 20030088873, 20030086682, 20030041159, 20020167956, and 20020143959, each of which is herein incorporated by reference in its entirety).

Thus, in some embodiments, the present invention provides a system for manipulating, annotating, and managing a plurality of remote, multimedia files in a server-side environment, the system comprising a host computer network configured to carry out one or more of the following: a) identify multimedia files on an Internet web site, b) present the multimedia files to a client computer, c) receive playlist selection information (i.e., information pertaining to the identity of the multimedia files to be selected, annotated, or otherwise designated or manipulated) from the client computer, said playlist selection information comprising multimedia file identity and multimedia file start and stop points (i.e., designations of the starting and ending points of the multimedia file to be played in a presentation), d) receive multimedia file annotation information from the client computer, e) catalog (i.e., organize in a database or similar format) playlist selection information and multimedia file annotation information from a plurality of web sites selected by the client computer, and f) combine those multimedia files and annotations into online publications.

The present invention is not limited by the nature of the multimedia files. For example, multimedia files include, but are not limited to, streaming media, audio information, video information, image information, and text information.

In some preferred embodiments, the computer network is configured to present the multimedia files to a client computer by displaying hyperlinks to the multimedia files on the client computer.

The present invention also provides a method for managing a plurality of multimedia files in a server-side environment, comprising one or more of the following steps: a) providing the systems of the present invention; b) identifying multimedia files on an Internet web site selected by the client computer; c) displaying identified multimedia files to the client computer; d) receiving the playlist selection information from the client computer; e) receiving the multimedia file annotation information from the client computer; f) storing the playlist selection information and the multimedia file annotation information to generate a multimedia presentation; and g) providing the client computer access to the multimedia presentation.

### DESCRIPTION OF THE FIGURES

FIG. 1 shows a demonstration of a search tool in one embodiment of the present invention.

FIG. 2 shows a demonstration of a search tool in one embodiment of the present invention.

FIG. 3 shows a demonstration of identified multimedia files in one embodiment of the present invention.

FIG. 4 shows a demonstration interactive multimedia annotation system in one embodiment of the present invention.

FIG. 5 shows a demonstration multimedia database in one embodiment of the present invention.

FIG. 6 shows a demonstration multimedia database in one embodiment of the present invention.

FIG. 7 shows a demonstration interactive multimedia annotation editing system in one embodiment of the present invention.

### DEFINITIONS

To facilitate an understanding of the present invention, a number of terms and phrases are defined below:

As used herein, the terms “processor” and “central processing unit” or “CPU” are used interchangeably and refer to a device that is able to read a program from a computer memory (e.g., ROM or other computer memory) and perform a set of steps according to the program.

As used herein, the terms “computer memory” and “computer memory device” refer to any storage media readable by a computer processor. Examples of computer memory include, but are not limited to, RAM, ROM, computer chips, digital video discs (DVD), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks.

As used herein, the terms “multimedia information,” “multimedia content,” and “media information” are used interchangeably to refer to information (e.g., digitized and analog information) encoding or representing audio, video, and/or text. Multimedia information may further carry information not corresponding to audio or video. Multimedia information may be transmitted from one location or device to a second location or device by methods including, but not limited to, electrical, optical, and satellite transmission, and the like.

As used herein, the term “audio information” refers to information (e.g., digitized and analog information) encoding or representing audio. For example, audio information may comprise encoded spoken language with or without additional audio. Audio information includes, but is not limited to, audio captured by a microphone and synthesized audio (e.g., computer generated digital audio).

As used herein, the term “video information” refers to information (e.g., digitized and analog information) encoding or representing video. Video information includes, but is not limited to video captured by a video camera, images captured by a camera, and synthetic video (e.g., computer generated digital video).

As used herein, the term “text information” refers to information (e.g., analog or digital information) encoding or representing written language or other material capable of being represented in text format (e.g., corresponding to spoken audio). For example, computer code (e.g., in .doc, .ppt, or any other suitable format) encoding a textual transcript of a spoken audio performance comprises text information. In addition to written language, text information may also encode graphical information (e.g., figures, graphs, diagrams, shapes) related to, or representing, spoken audio. “Text information corresponding to audio information” comprises text information (e.g., a text transcript) substantially representative of a spoken audio performance. For example, a text transcript containing all or most of the words of a speech comprises “text information corresponding to audio information.”

As used herein, the term “configured to receive multimedia information” refers to a device that is capable of receiving multimedia information. Such devices contain one or more components that can receive a signal carrying multimedia information. In preferred embodiments, the receiving component is configured to transmit the multimedia information to a processor.

As used herein, the term “encode” refers to the process of converting one type of information or signal into a different type of information or signal to, for example, facilitate the transmission and/or interpretability of the information or signal. For example, audio sound waves can be converted into (i.e., encoded into) electrical or digital information. Likewise, light patterns can be converted into electrical or digital information that provides and encoded video capture of the light patterns. As used herein, the term “separately encode” refers to two distinct encoded signals, whereby a first encoded set of information contains a different type of content than a second encoded set of information. For example, multimedia information containing audio and video information is separately encoded where video information is encoded into one set of information while the audio information is encoded into a second set of information. Likewise, multimedia information is separately encoded where audio information is encoded and processed in a first set of information and text corresponding to the audio information is encoded and/or processed in a second set of information.

As used herein, the term “information stream” refers to a linearized representation of multimedia information (e.g., audio information, video information, text information). Such information can be transmitted in portions over time (e.g., file processing that does not require moving the entire file at once, but processing the file during transmission (the stream)). For example, streaming audio or video information utilizes an information stream. As used herein, the term “streaming” refers to the network delivery of media. “True streaming” matches the bandwidth of the media signal to the viewer's connection, so that the media is seen in real time. As is known in the art, specialized media servers and streaming protocols are used for true streaming. RealTime Streaming Protocol (RTSP, REALNETWORKS) is a standard used to transmit true streaming media to one or more viewers simultaneously. RTSP provides for viewers randomly accessing the stream, and uses RealTime Transfer Protocol (RTP, REALNETWORKS) as the transfer protocol. RTP can be used to deliver live media to one or more viewers simultaneously. “HTTP streaming” or “progressive download” refers to media that may be viewed over a network prior to being fully downloaded. Examples of software for “streaming” media include, but are not limited to, QUICKTIME, NETSHOW, WINDOWS MEDIA, REALVIDEO, REALSYSTEM G2, and REALSYSTEM 8. A system for processing, receiving, and sending streaming information may be referred to as a “stream encoder” and/or an “information streamer.”

As used herein, the term “digitized video” refers to video that is either converted to digital format from analog format or recorded in digital format. Digitized video can be uncompressed or compressed into any suitable format including, but not limited to, MPEG-1, MPEG-2, DV, M-JPEG or MOV. Furthermore, digitized video can be delivered by a variety of methods, including playback from DVD, broadcast digital TV, and streaming over the Internet. As used herein, the term “video display” refers to a video that is actively running, streaming, or playing back on a display device.

As used herein, the term “codec” refers to a device, either software or hardware, that translates video or audio between its uncompressed form and the compressed form (e.g., MPEG-2) in which it is stored. Examples of codecs include, but are not limited to, CINEPAK, SORENSON VIDEO, INDEO, and HEURIS codecs. “Symmetric codecs” encodes and decodes video in approximately the same amount of time. Live broadcast and teleconferencing systems generally use symmetric codecs in order to encode video in real time as it is captured.

As used herein, the term “compression format” refers to the format in which a video or audio file is compressed. Examples of compression formats include, but are not limited to, MPEG-1, MPEG-2, MPEG-4, M-JPEG, DV, and MOV.

As used herein, the term “client-server” refers to a model of interaction in a distributed system in which a program at one site sends a request to a program at another site and waits for a response. The requesting program is called the “client,” and the program that responds to the request is called the “server.” In the context of the World Wide Web (discussed below), the client is a “Web browser” (or simply “browser”) that runs on a computer (e.g., desktop, cell phone, hand-held, etc.) of a user; the program which responds to browser requests by serving Web pages is commonly referred to as a “Web server.”

As used herein, the term “hyperlink” refers to a navigational link from one document to another, or from one portion (or component) of a document to another. Typically, a hyperlink is displayed as a highlighted word or phrase that can be selected by clicking on it using a mouse to jump to the associated document or documented portion.

As used herein, the term “hypertext system” refers to a computer-based informational system in which documents (and possibly other types of data entities) are linked together via hyperlinks to form a user-navigable “web.”

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc). The term is also intended to encompass non-public networks such as private (e.g., corporate) Intranets.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

As used herein, the term “web site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “HTML” refers to HyperText Markup Language that is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally, in specifying how the Web browser is to display the document, HTML tags can be used to create links to other Web documents (commonly referred to as “hyperlinks”).

As used herein, the term “HTTP” refers to HyperText Transport Protocol that is the standard World Wide Web client-server protocol used for the exchange of information (such as HTML documents, and client requests for such documents) between a browser and a Web server. HTTP includes a number of different types of messages that can be sent from the client to the server to request different types of server actions. For example, a “GET” message, which has the format GET, causes the server to return the document or file located at the specified URL.

As used herein, the term “URL” refers to Uniform Resource Locator that is a unique address that fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

As used herein, the term “PUSH technology” refers to an information dissemination technology used to send data to users over a network. In contrast to the World Wide Web (a “pull” technology), in which the client browser must request a Web page before it is sent, PUSH protocols send the informational content to the user computer automatically, typically based on information pre-specified by the user.

As used herein, the terms “live event” and “live media event” are used interchangeably to refer to an event that is to be captured in the form of audio, video, text, or multimedia information, wherein the captured information is used to transmit a representation of the event (e.g., a video, audio, or text capture of the event) to one or more viewers in real time or substantially real time (i.e., it will be appreciated that delays on the order of seconds to minutes may be incurred in the capture, delivery, and/or processing of information prior to its display to viewers while still considering the display of the event as a “live” event). As used herein, “live event audio” refers to audio from a live event that is captured as audio information and transmitted, in some form, to a viewer in real time. As used herein, “live educational event” refers to a live event featuring an educational component directed at the viewer.

As used herein, the term “event audio” refers to the audio component of an event. Events include any live performance, prerecorded performance, and artificially synthesized performance or any kind (e.g., any event or material that contains speech).

As used herein, the term “distinct locations” refers to two or more different physical locations where viewers can separately view a multimedia presentation. For example, a person viewing a presentation in one location (e.g., on a video monitor) would be in a distinct location from a second person viewing the same presentation (e.g., on a different video monitor) if the first and second persons are located in different rooms, cities, countries, and the like.

As used herein, the term “security protocol” refers to an electronic security system (e.g., hardware and/or software) to limit access to processor to specific users authorized to access the processor. For example, a security protocol may comprise a software program that locks out one or more functions of a processor until an appropriate password is entered.

As used herein, the term “viewer” refers to a person who views text, audio, video, or multimedia content. Such content includes processed content such as information that has been processed and/or translated using the systems and methods of the present invention. As used herein, the phrase “view multimedia information” refers to the viewing of multimedia information by a viewer.

As used herein, the term “resource manager” refers to a system that optimizes the performance of a processor or another system. For example a resource manager may be configured to monitor the performance of a processor or software application and manage data and processor allocation, perform component failure recoveries, optimize the receipt and transmission of data (e.g., streaming information), and the like. In some embodiments, the resource manager comprises a software program provided on a computer system of the present invention.

As used herein, the term “viewer output signal” refers to a signal that contains multimedia information, audio information, video information, and/or text information that is delivered to a viewer for viewing the corresponding multimedia, audio, video, and/or text content. For example, viewer output signal may comprise a signal that is receivable by a video monitor, such that the signal is presented to a viewer as text, audio, and/or video content.

As used herein, the term “compatible with a software application” refers to signals or information configured in a manner that is readable by a software application, such that the software application can convert the signal or information into displayable multimedia content to a viewer.

As used herein, the term “in electronic communication” refers to electrical devices (e.g., computers, processors, conference bridges, communications equipment) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc) information to another computer or device, is in electronic communication with the other computer or device.

As used herein, the term “transmitting” refers to the movement of information (e.g., data) from one location to another (e.g., from one device to another) using any suitable means.

As used herein, the term “player” (e.g., multimedia player) refers to a device or software capable of transforming information (e.g., multimedia, audio, video, and text information) into displayable content to a viewer (e.g., audible, visible, and readable content).

### DETAILED DESCRIPTION OF THE INVENTION

The present invention comprises systems and methods for identifying, segmenting, collecting, annotating, and publishing multimedia materials. Certain preferred embodiments of the present invention are described in detail below. These illustrative examples are not intended to limit the scope of the invention. The description is provided in the following sections: I) Identifying, Segmenting, Collecting, Annotating, and Publishing Multimedia Materials, and II) Applications.

I. Identifying, Segmenting, Collecting, Annotating, and Publishing Multimedia Materials

The following is a detailed, step-by-step description of one preferred embodiment of the present invention. This illustrative example is provided in the following seven sections:
A. Locating Multimedia Content
B. Loading Multimedia Content into a Player
C. Controlling Multimedia Content Playback
D. Segmenting Multimedia Content
E. Annotating Multimedia Content
F. Organizing Multimedia Content as a Presentation
G. Publishing a Presentation for Access by Others
   A. Locating Multimedia Content

The present invention provides systems and methods for locating multimedia content on a computer network. In preferred embodiments of the present invention, multimedia content is located automatically. In some embodiments, all or some of the multimedia content at a particular location on a computer network (e.g., a page on the World Wide Web portion of the Internet) is automatically identified and indexed. In other embodiments, the computer network is searched automatically to identify and index multimedia files. In some embodiments, a “smart” search is conducted on web page, or on the World Wide Web in general, for files of a particular type (e.g., particular extension such as .rm or particular file name as a proxy for the topic of the multimedia event). In yet other embodiments, the particular location to be searched and indexed is selected by a user.

In preferred embodiments, the computer network is accessed via a software-based browser. Examples of software-based browsers that may be used with the present invention include Internet Explorer (Microsoft), Navigator (Netscape), Communicator (Netscape), Safari (Apple), Opera (Opera), and Mozilla (Mozilla), although any software-based browser or related technology may be used.

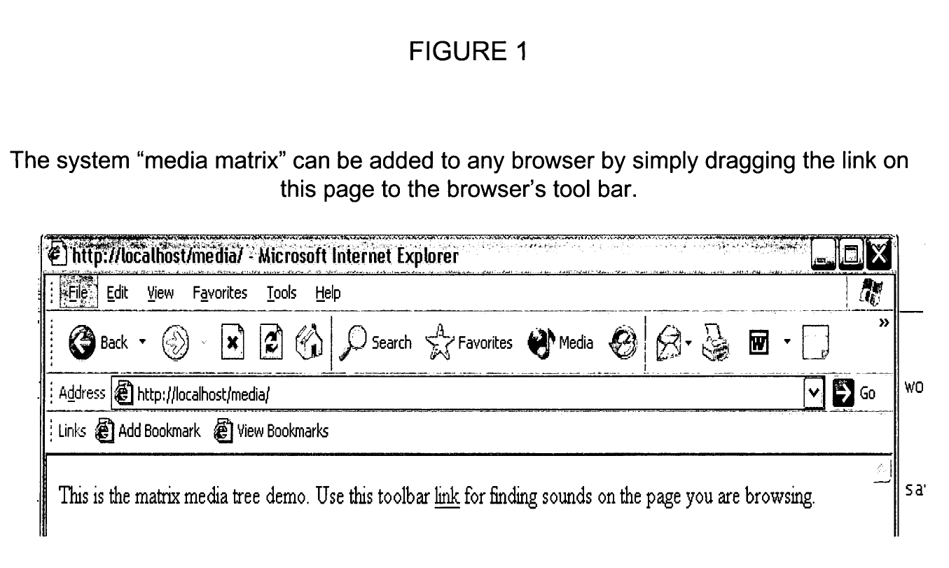

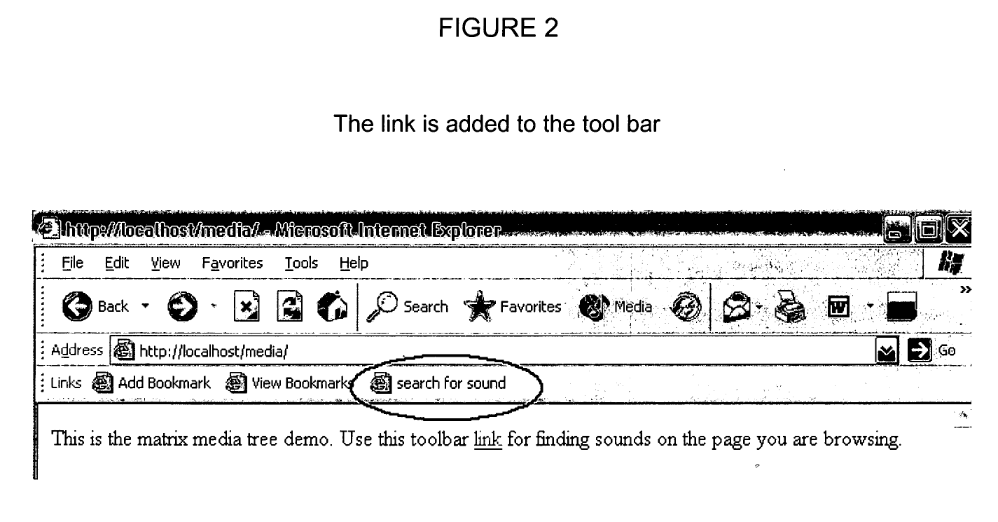

In some embodiments of the present invention, the functionality of the browser is extended by means of one or more separate computer programs (hereinafter referred to as “applications”) that are stored in one or more remote locations (e.g., locations other than locally on the user's computer). In preferred embodiments, functionality for locating multimedia content is added to a browser via one or more hyperlinks that launch the remote applications. FIG. 1 shows an example of multimedia content search functionality that can be added to a browser by means of a hyperlink. The hyperlink may be stored by the browser in a manner that renders it easily accessible, such as on a browser's toolbar or in a list of bookmarks. FIG. 2 shows a browser window in which a hyperlink adding multimedia content search functionality has been added to the browser's toolbar for convenient access. The hyperlink connects the user to a remote server via a computer network (e.g., the Internet). Software (e.g., one or more applets) that is stored on the remote server allows any location on a computer network to be automatically searched for multimedia content simply by accessing the hyperlink from that location. In preferred embodiments, the location to be searched is an Internet web page, although any accessible location on a computer network may be searched for multimedia content.

B. Loading Multimedia Content Into a Player

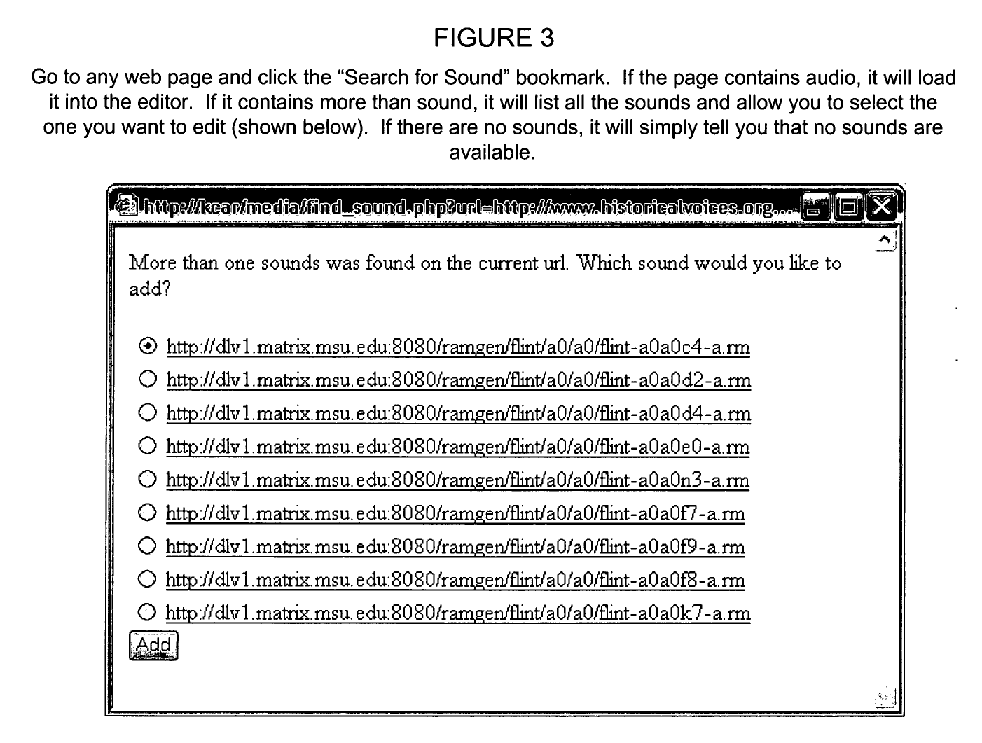

After a location on a computer network is searched, the results of the search are displayed in a window. Any multimedia content found at the searched location can be displayed. The display can be arranged by media type (e.g., video, audio, image, text, etc.), file type, file name, location (e.g., URL), or by any other desired means. FIG. 3 shows a browser window in which the results of a search for multimedia content on a web page are displayed by location. In preferred embodiments of the present invention, the data comprising the search results may be stored by software on a remote server. The stored data includes information useful to locate, identify, and categorize the multimedia files, but preferably excludes the multimedia files themselves. As shown in FIG. 3, a means is provided for a user to select one or more of the identified multimedia files for access.

After a desired multimedia file has been selected, software directs the browser to load the file into a browser-based multimedia player that is compatible with the file type of the selected multimedia file. Examples of browser-based multimedia players that may be used with the present invention include RealPlayer (Real Networks), Windows Media Player (Microsoft), and QuickTime Player (Apple), although any browser-based multimedia player may be used.

C. Controlling Multimedia Content Playback

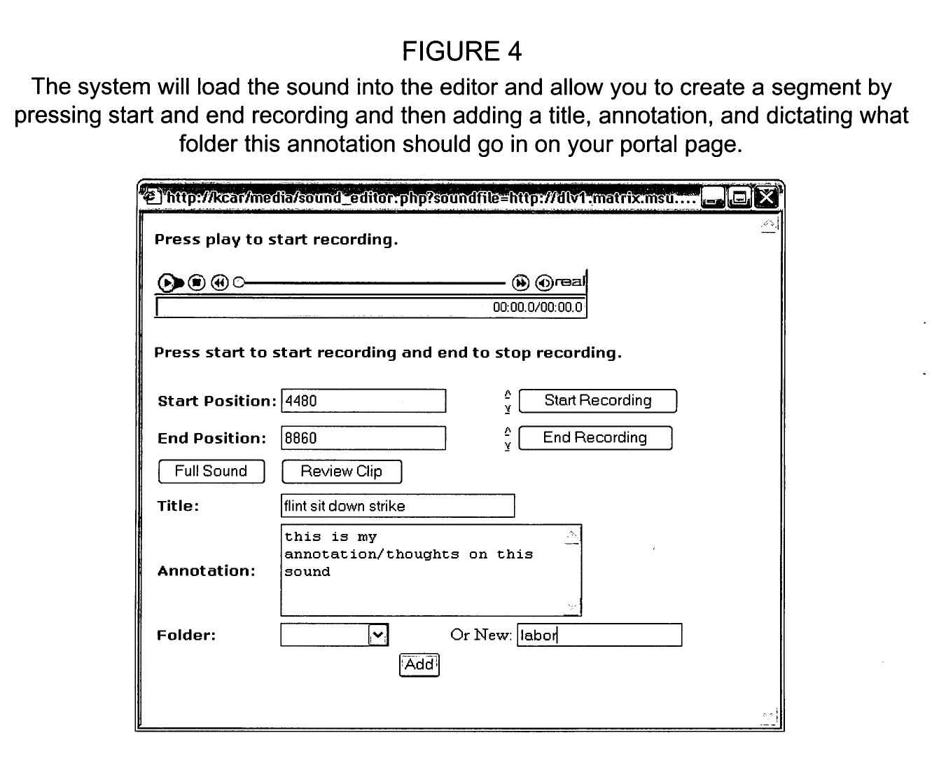

The selected multimedia file and compatible multimedia player are then displayed in a browser window. FIG. 4 shows a browser window in which a user-selected multimedia file and a compatible multimedia player are displayed. The window is configured to provide user access to the playback controls of the multimedia player. In preferred embodiments, the playback controls include the functions typical to most multimedia players, including, but not limited to, the ability to start, stop, and pause playback in real time, move in forward and reverse at speeds faster and slower than real time (e.g., fast-forward, rewind, slow motion, etc.), and adjust playback conditions (e.g., audio volume, image brightness and contrast, etc.). In some embodiments, software that is stored on a remote server allows a user to save and store the desired playback parameters (e.g., audio volume) associated with a selected multimedia file. The stored playback parameters may be retrieved from the remote server and used whenever the associated multimedia file is accessed.

D. Segmenting Multimedia Content

As shown in FIG. 4, a user-selected multimedia file and compatible multimedia player are directed by software to be displayed in a browser window. In preferred embodiments, the browser window contains additional tools for segmenting multimedia files. In particularly preferred embodiments, the segmenting tools allow a user to generate time-based index points for a multimedia file (e.g., spatial parameters for image files). The use of time-based/spatial-based index points provides a means for the virtual segmentation of a multimedia file, allowing a user to create “clips” of specified portions. Playback of the multimedia file may be started or stopped at any point in the file's timeline. The data associated with the time-based index points may be saved and stored on a remote server, and may be retrieved from the remote server and used whenever the associated multimedia file is accessed. Because the systems and methods of the present invention utilize time-based/spatial-based index points, multimedia editing may be achieved without the need to permanently store multimedia files, or divide them into separate files corresponding to each selected “clip.” The only data required to be stored for the purpose of segmenting multimedia files is the data associated with the time-based index points. The benefits of this approach include vastly decreased storage needs (multimedia files are often very large), faster access speeds over a computer network, and diminished copyright implications.

E. Annotating Multimedia Content

The systems and methods of the present invention provide a means for a user to add annotative information to a multimedia file. In preferred embodiments, such user-created annotative information includes a title, annotative notes, and a designated location for storage and retrieval of the annotative information. FIG. 4 shows a browser window for editing of multimedia content that includes a multimedia file loaded into a compatible multimedia player, controls for generating time-based index points for virtual segmentation of the multimedia file, and a means of entering annotative information. In preferred embodiments, such annotative information is entered via one or more text fields in a browser window. Annotative information typically comprises text information, although any type of multimedia data may be used (e.g., audio, video, image, etc.). User-generated annotations may be used for any annotative purpose, including, but not limited to, providing contextual information, critical commentary, or descriptive information about the associated multimedia file.

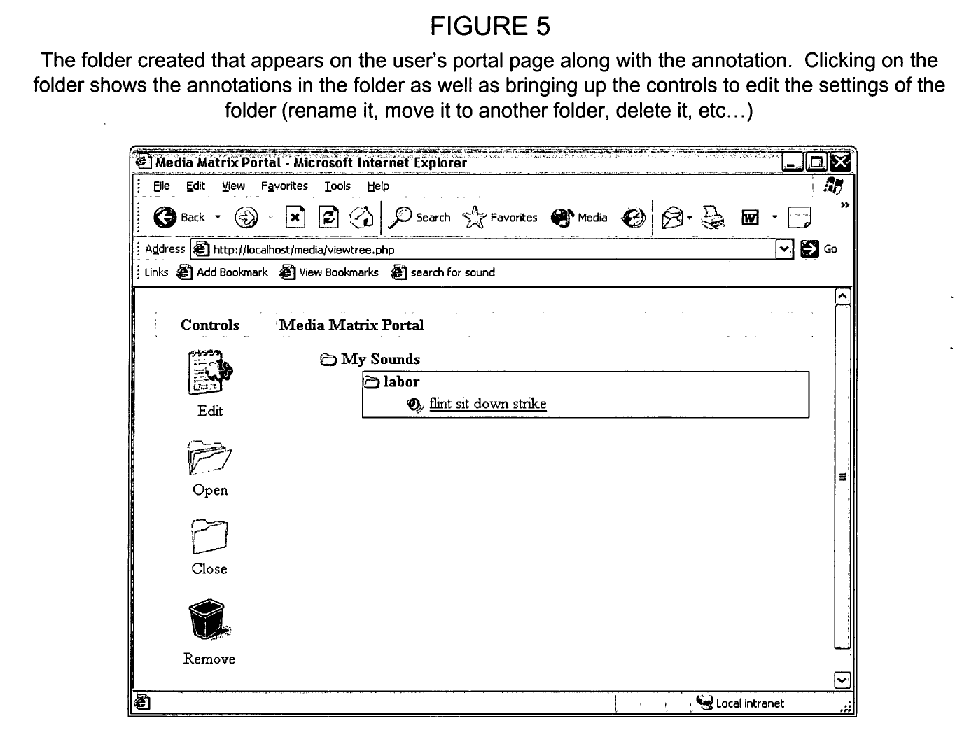

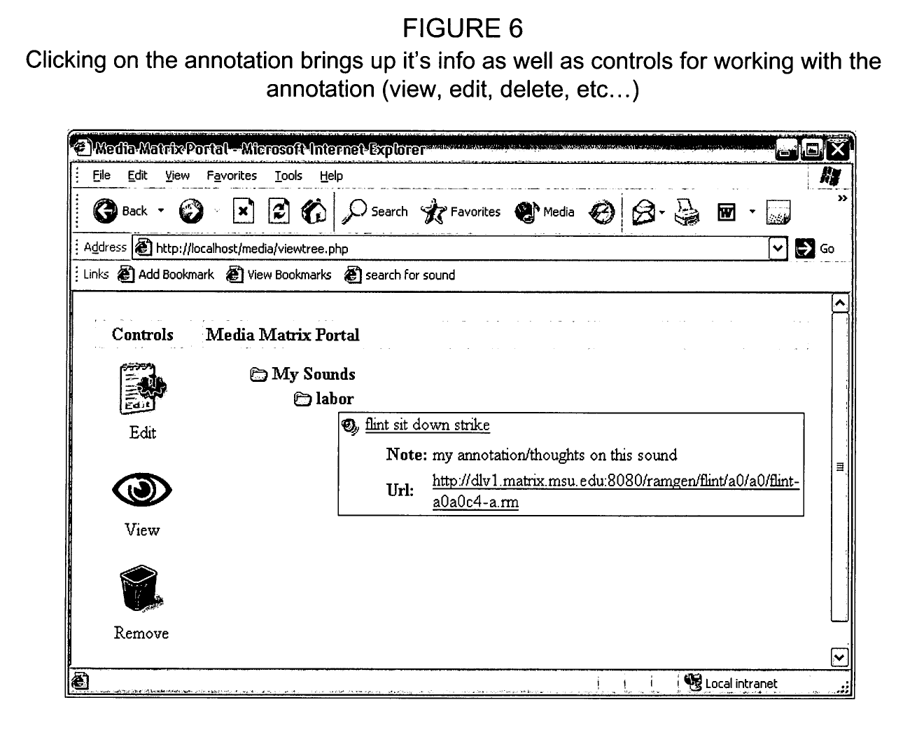

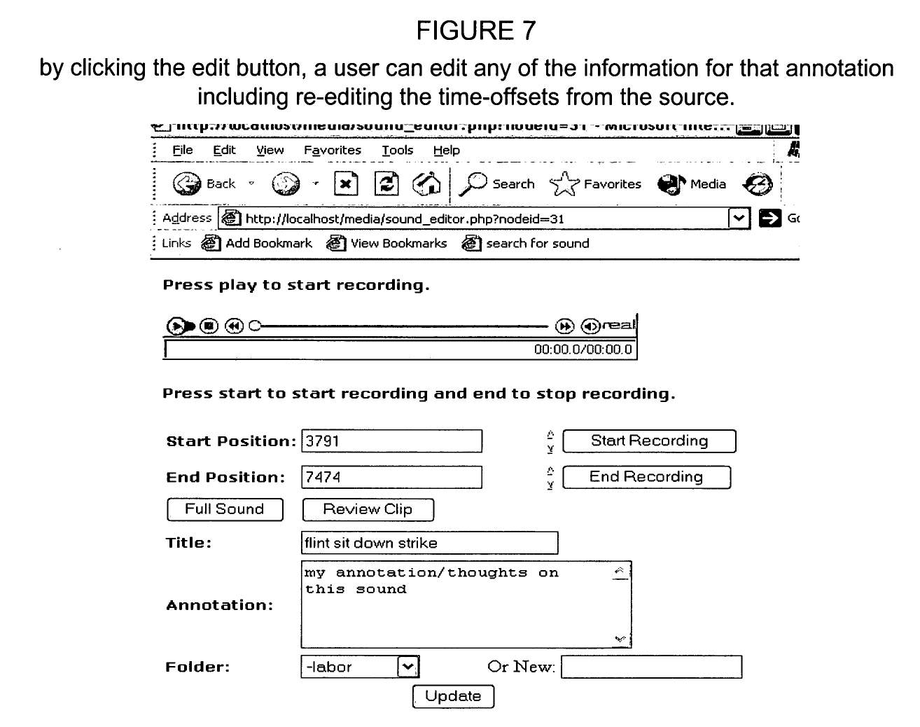

After a user designates a location for storage and retrieval of the annotative information, the information appears on the user's personal portal page that can be accessed through a browser window. FIG. 5 shows a browser window displaying a user-created directory of annotative information associated with multimedia files. In preferred embodiments of the present invention, the directory allows a user to select, open, edit, close, or delete the annotative information associated with a multimedia file. FIG. 6 shows a browser window in which saved annotative information has been selected from the directory shown in FIG. 5. When a user selects an annotation, data comprising the annotative information is displayed in the browser window, allowing the user to determine the contents of an annotation prior to opening it for editing. FIG. 7 shows a saved annotation that has been opened via the directory for further editing. In preferred embodiments, annotations may be freely created, edited, and deleted without limitation.

F. Organizing Multimedia Content as a Presentation

The systems and methods of the present invention may be used to create user-customizable multimedia presentations comprising multimedia files, segment information, and annotative information. In preferred embodiments, software that is stored on a remote server allows a user to save and store segment and annotative information associated with one or more multimedia files. Because the systems and methods of the present invention utilize time and/or spatial-based index points and annotations, multimedia presentations may be created without the need to permanently store multimedia files, or divide them into separate files corresponding to each selected “clip.” In some embodiments, software that is stored on a remote server provides one or more templates upon which a multimedia presentation may be based. In preferred embodiments, both preset and customizable templates are provided. In other embodiments, the multimedia presentation is executed by means of a specialized programming language. In particularly preferred embodiments, the multimedia presentation is executed by means of Synchronized Multimedia Integration Language (“SMIL”). In yet other embodiments, the multimedia presentation is executed by means of Hypertext Markup Language (“HTML”), although any suitable programming language may be used.

G. Publishing a Presentation for Access by Others

The systems and methods of the present invention may be used to publish stored multimedia presentations by making them available for access by others over a computer network (e.g., the Internet). For example, a first user in a first location may create a multimedia presentation that is stored entirely on a remote server. In preferred embodiments of the present invention, one or more additional users in one or more separate and distinct locations on a computer network may access the multimedia presentation created by the first user. In some embodiments, one or more additional users can contribute their own multimedia content, segment information, and annotative information to a multimedia presentation originally created by a first user. Because the systems and methods of the present invention utilize time-based index points and annotations, multimedia presentations may be created, stored, and accessed without the need to permanently store multimedia files. In addition, the server-side approach of the present invention eliminates the necessity of storing any of the data associated with the multimedia presentation on a user's local computer.

II. Applications

As will be clear from the above description, the present invention provides systems and methods with a broad range of applications. Illustrative, non-limiting examples are provided below.

While having much broader application, the present invention was devised as a way for teachers and students to easily use multimedia materials in their teaching and learning. For example, the system allows for the generation of multimedia presentation and reports. The system also provides means for courseware manufacturers to enhance courseware packages.

Libraries, repositories, and archives could avoid the expensive and time consuming procedure of creating derivatives of a digital object (creating small files from a larger file) and storing and delivering those multiple version of the same file. The system also allows re-use of user generated information as metadata by libraries, repositories, and archives.

The medical and veterinary fields could easily annotate and associate stored information with video tapings of procedures. The business sector could create annotated training manuals for their staff and customers and provide enhanced presentations for business meetings and video conferencing. The athletic community could quickly and easily annotate game tape with this system. Additionally, the legal field could use the system to manage and present audio or video testimony, particularly for large cases where select portions of large numbers of audio or video depositions are desired. Additional uses include home video and audio editing (e.g., video/audio scrapbooking), web page development, job training, and the like.

All publications and patents mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A system for managing a plurality of multimedia files in a server-side environment, comprising a host computer network configured to: a) identify multimedia files on an Internet web site, b) present said multimedia files to a client computer, c) receive playlist selection information from said client computer, said playlist selection information comprising multimedia file identity and multimedia file start and stop points d) receive multimedia file annotation information from said client computer, and e) catalog playlist selection information and multimedia file annotation information from a plurality of web sites selected by said client computer.

2. The system of claim 1, wherein said playlist selection information further comprises spatial parameters for clipping and resizing an image.

3. The system of claim 1, wherein said multimedia files comprise streaming media.

4. The system of claim 1, wherein said multimedia files comprise audio information.

5. The system of claim 1, wherein said multimedia files comprise video information.

6. The system of claim 1, wherein said multimedia files comprise image information.

7. The system of claim 1, wherein said multimedia files comprise text information.

8. The system of claim 1, wherein said computer network is configured to present said multimedia files to a client computer by displaying hyperlinks to said multimedia files on said client computer.

9. The system of claim 1, wherein said start and stop points comprise start and stop points in a streaming media file.

10. The system of claim 2, wherein said spatial dimensions allow for the clipping and resizing of images.

11. A method for managing a plurality of multimedia files in a server-side environment, comprising:
a) providing the system of claim 1;
b) identifying multimedia files on an Internet web site selected by said client computer,
c) displaying identified multimedia files to said client computer;
d) receiving said playlist selection information from said client computer;
e) receiving said multimedia file annotation information from said client computer;
f) storing said playlist selection information and said multimedia file annotation information to generate a multimedia presentation; and
g) providing said client computer access to said multimedia presentation.

12. The method of claim 11, wherein said multimedia files comprise streaming media.

13. The method of claim 11, wherein said multimedia files comprise audio information.

14. The method of claim 11, wherein said multimedia files comprise video information.

15. The method of claim 11, wherein said multimedia files comprise image information.

16. The method of claim 11, wherein said multimedia files comprise text information.

17. The method of claim 11, wherein said displaying identified multimedia files to said client computer comprises displaying hyperlinks to said multimedia files on said client computer.

18. The method of claim 11, wherein said start and stop points comprise start and stop points in a streaming media file.
